(19) United States
(12) Patent Application Publication
(10) Pub. No.: US 2005/0156906 A1
(43) Pub. Date: Jul. 21, 2005

(54) Capacitive touchpad and method for forming the same

(76) Inventors: Yen-Chang Chiu, Linkou Shiang (TW); Yung-Lieh Chien, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/028,308

(22) Filed: Jan. 4, 2005

(30) Foreign Application Priority Data
Jan. 7, 2004 (TW) 093100351

(51) Int. Cl. G09G 5/00

(52) U.S. Cl. 345/173

(57) ABSTRACT

A capacitive touchpad comprises a membrane and a printed circuit board combined together. The membrane comprises an X trace and a Y trace with an insulator layer inserted therebetween, and the printed circuit board has connection pads on a top side of a substrate that are electrically connected to the X and Y traces. The printed circuit board further comprises vias connected between the connection pads and a conductor layer on the bottom side of the substrate. To form the capacitive touchpad, the membrane and printed circuit board are individually produced in advance, and then combined together. Alternatively, the membrane is printed on the printed circuit board.

### FIELD OF THE INVENTION

The present invention is related generally to a capacitive touchpad and a method for forming the capacitive touchpad, and more particularly, to a capacitive touchpad including a membrane thereof and a method for forming the capacitive touchpad.

### BACKGROUND OF THE INVENTION

Touchpad has found wide applications in various electronic products, and conventionally, there are three types of touchpad, i.e., resistive, electromagnetic, and capacitive ones. Theoretically, the capacitive touchpad determines the position that is touched by finger or conductor by sensing the instant capacitance change resulted from the touch of the finger or conductor. Typically, a conventional capacitive touchpad is constructed with four-layer printed circuit board (PCB), including a ground plane, an X trace, a Y trace, and a layer of circuit. However, the manufacturing cost of such capacitive touchpad is relatively high.

For cost down, it was proposed a capacitive touchpad constructed with two-layer PCB. Unfortunately, the electrical performance of such capacitive touchpad is much poorer than that of one based on four-layer PCB, and thus, its application in the industry is not significant.

On the other hand, the dielectrics in conventional capacitive touchpads are opaque, thereby restricting their applications for electronic products. Therefore, it is desired a capacitive touchpad of low cost and available for more applications.

### SUMMARY OF THE INVENTION

One object of the present invention is to provide a capacitive touchpad constructed with a membrane and a PCB, and a method to produce the capacitive touchpad, thereby reducing the cost of the capacitive touchpad and the method for forming the capacitive touchpad.

Another object of the present invention is to provide a capacitive touchpad constructed with a membrane and a PCB, and a method to produce the capacitive touchpad, such that a transparent capacitive touchpad is obtained.

According to the present invention, a capacitive touchpad is constructed by combining a membrane with a PCB. The membrane includes X trace and Y trace with insulator layer inserted therebetween, and the PCB has connection pads on a substrate electrically connected to the X and Y traces. The PCB further includes vias connected between the connection pads and a conductor layer on the bottom side of the substrate.

In a method to form the capacitive touchpad, the membrane and PCB are individually produced in advance, and then combined together.

Alternatively, a method to form the capacitive touchpad comprises forming the membrane on the PCB by printing and pressing.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a diagram to illustrate the structure of a first embodiment capacitive touchpad according to the present invention;

FIG. 2 shows exemplary patterns of the conductor layers 18 and 22 of the membrane 12 in FIG. 1;

FIG. 3 shows one exemplary pattern of the conductor layer 26 of the PCB 14 in FIG. 1;

FIG. 4 shows a diagram to illustrate the structure of a second embodiment capacitive touchpad according to the present invention; and

FIG. 5 shows exemplary patterns of the conductor layers 208 and 212 of the membrane 202 in FIG. 4.

### DETAILED DESCRIPTION OF THE INVENTION

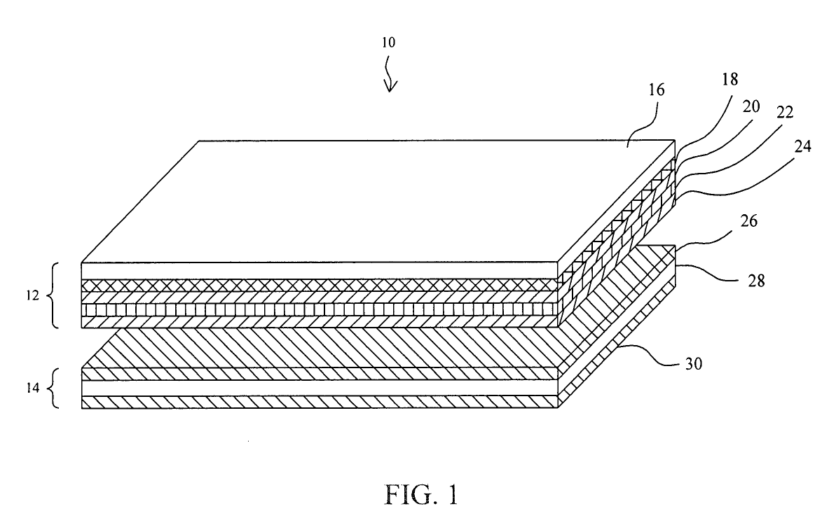

FIG. 1 shows a diagram to illustrate the structure of a first embodiment capacitive touchpad 10 that comprises a membrane 12 and a PCB 14 combined together. The membrane 12 is served as the analog sense apparatus of the capacitive touchpad 10, and constructed with sandwich structure including a first insulator layer 16, a first conductor layer 18, a second insulator layer 20, a second conductor layer 22, and a third insulator layer 24 sequentially in stack. The insulator layer 16 is used as the substrate of the membrane 12, and may be made of transparent insulator such as polyester (PET), or opaque insulator such as plastic, ceramic and polymer. The Y trace of the capacitive touchpad 10 is included in the conductor layer 18, the X trace is included in the conductor layer 22, and both of them are made of material with low resistance, for example silver glue. The insulator layer 20 provides the insulation between the conductor layers 18 and 22, and the insulator layer 24 is for the insulation between the conductor layer 22 and the PCB 14. The insulator layers 22 and 24 are preferably made of material with dielectric constant of 2-4, for example transparent insulator such as ink, or opaque insulator such as plastic, paper and polymer. The PCB 14 includes two conductor layers 26 and 30 on the opposite sides of a substrate 28. The conductor layer 26 on the top side of the PCB 14 may provide a ground plane, and the conductor layer 30 on the bottom side is for forming the electric circuit and placing electronic devices thereon. The conductor layers 26 and 30 may be made of copper film, and the substrate 28 may include a glass fiber (FR4)-based plate, as a typical PCB.

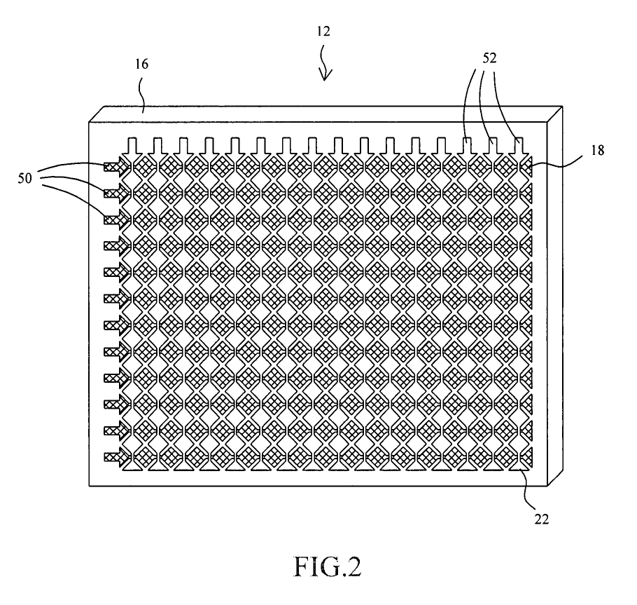

FIG. 2 shows exemplary patterns of the conductor layers 18 and 22 of the membrane 12 in FIG. 1. With the insulator layer 16 as a substrate, the conductor layers 18 and 22 are printed thereon. The conductor layer 18 includes the Y trace of the capacitive touchpad 10 that has trace joints 50 at its edge, the conductor layer 22 includes the X trace that has trace joints 52 at its edge, and both of the trace joints 50 and 52 are electrically connected to the connection pads on the conductor layer 26 of the PCB 14.

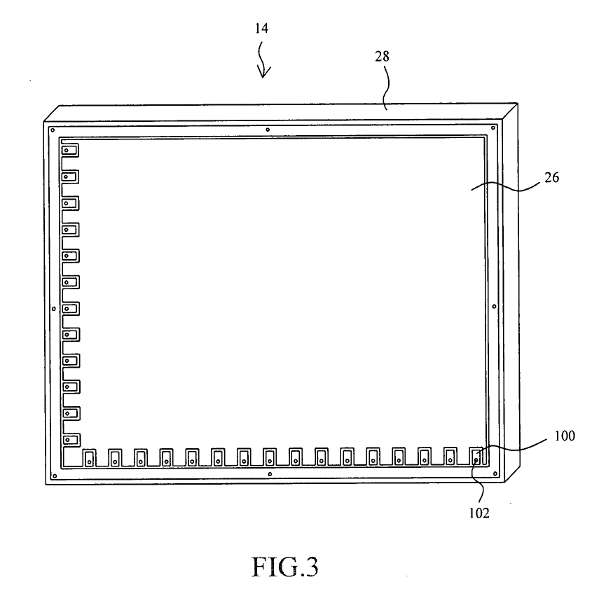

FIG. 3 shows one exemplary pattern of the conductor layer 26 of the PCB 14 in FIG. 1. The conductor layer 26 on the substrate 28 is attached with the insulator layer 24 of the membrane 12, and the conductor layer 26 provides the ground plane of the capacitive touchpad 10 and has connection pads 100 at the positions corresponding to the trace joints 50 and 52 of the membrane 12. The connection pads 100 and trace joints 50 and 52 are coated with conductive glue therebetween and then thermally pressed under high temperature for forming electrical connection therebetween. Vias 102 through the substrate 28 are provided for connecting the conductor layers 18 and 22 of the membrane 12 to the circuit of the conductor layer 30 on the bottom side of the PCB 14.

In a method to form the capacitive touchpad 10, the membrane 12 and PCB 14 are produced individually in advance. Referring to FIG. 1, to produce the membrane 12, the insulator layer 16 is used as the substrate to print thereon with the conductor layer 18, insulator layer 20, conductor layer 22 and insulator layer 24 one by one, and to produce the PCB 14, the conductor layer 30 is etched to form the circuit. To combine the PCB 14 with the membrane 12, referring to FIGS. 2 and 3, the trace joints 50 and 52 are attached onto the connection pads 100 by thermal pressing with conductive glue therebetween, such that the conductor layers 18 and 22 are electrically connected to the circuit of the conductor layer 30, and then, electronic devices are placed and soldered on the conductor layer 30.

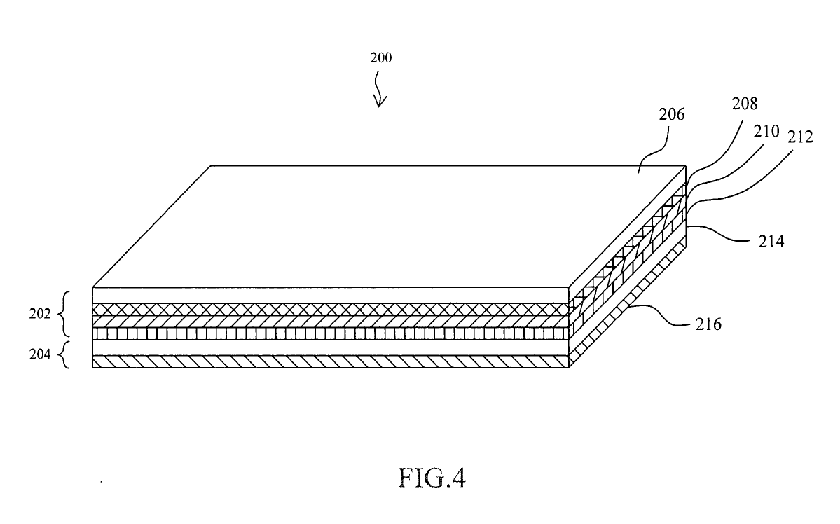

FIG. 4 shows a diagram to illustrate the structure of a second embodiment capacitive touchpad 200 that also comprises a membrane 202 and a PCB 204, and also employs the membrane 202 served as the analog sense apparatus, while the membrane 12 is constructed with four-layer sandwich including a first insulator layer 206, a first conductor layer 208, a second insulator layer 210 and a second conductor layer 212 sequentially in stack. The insulator layer 206 may be made of transparent insulator such as PET, or opaque insulator such as plastic, ceramic and polymer. The Y trace of the capacitive touchpad 200 is included in the conductor layer 208, the X trace is included in the conductor layer 212, and both of them are made of material with low resistance, for example silver glue. The insulator layer 210 providing the insulation between the conductor layers 208 and 212 has dielectric constant of 2-4, and may be made of transparent insulator such as ink, or opaque insulator such as plastic, paper and polymer. The PCB 204 comprises a substrate 214, for example glass fiber-based plate, and a conductor layer 216 on its bottom side, for example copper film, for forming the electric circuit and placing electronic devices thereon.

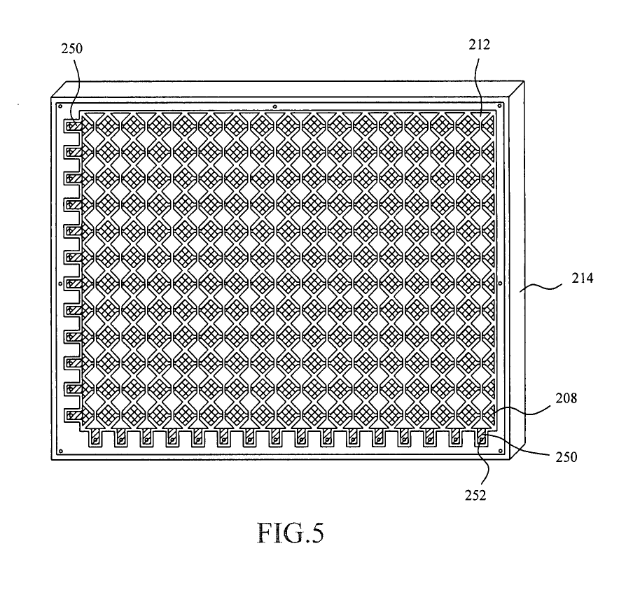

FIG. 5 shows exemplary patterns of the conductor layers 208 and 212 of the membrane 202 in FIG. 4. There are connection pads 250, for example made of copper film, provided on the substrate 214 of the PCB 204, and the conductor layers 212 and 208 are printed thereon further and electrically connected to the connection pads 250. Vias 252 through the substrate 214 are provided for connecting the conductor layers 208 and 212 of the membrane 202 to the circuit of the conductor layer 216 on the bottom side of the PCB 204.

In a method to form the capacitive touchpad 200, the PCB 204 is produced in advance and then used as the substrate to print the structure of the membrane 202 thereon. In particular, referring to FIGS. 4 and 5, the method comprises etching the conductor layer 216 on the bottom side of the PCB 204 to form the desired circuit, printing the conductor layer 212, insulator layer 210 and conductor layer 208 thereon sequentially with the X and Y traces electrically connected to the connection pads 250, attaching the top insulator layer 206 thereon, and placing and soldering electronic devices onto the conductor layer 216.

The capacitive touchpad according to the present invention has at least the advantages of excellent electrical performance and low manufacturing cost, and the method for forming such capacitive touchpad is simple and time-saving. Moreover, the capacitive touchpad according to the present invention can be made transparent, and could have more applications for the industrial products.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A capacitive touchpad comprising:
a membrane having a sandwich structure including a first insulator layer, a Y trace, a second insulator layer, an X trace, and a third insulator layer sequentially in stack; and
a printed circuit board having a first conductor layer electrically connected to the X and Y traces and a second conductor layer on a first surface and a second surface of a substrate, respectively, and a plurality of vias electrically connected between the first and second conductor layers.

2. The capacitive touchpad of claim 1, wherein the first to third insulator layers each comprises a transparent insulator.

3. The capacitive touchpad of claim 1, wherein the first to third insulator layer each comprises an opaque insulator.

4. The capacitive touchpad of claim 1, wherein the X and Y traces each comprises a conductive material of low resistance.

5. The capacitive touchpad of claim 4, wherein the conductive material of low resistance comprises a silver glue.

6. The capacitive touchpad of claim 1, wherein the second and third insulator layers each comprises a dielectric constant of 2-4.

7. The capacitive touchpad of claim 1, wherein the second and third insulator layers each comprises a transparent insulator.

8. The capacitive touchpad of claim 1, wherein the second and third insulator layers each comprises a layer of ink.

9. The capacitive touchpad of claim 1, wherein the first and second conductor layers each comprises a copper film.

10. The capacitive touchpad of claim 1, wherein the substrate comprises a glass fiber-based plate.

11. A capacitive touchpad comprising:
a membrane having a sandwich structure including a first insulator layer, a Y trace, a second insulator layer, and an X trace sequentially in stack; and
a printed circuit board having a plurality of connection pads electrically connected to the X and Y traces and a conductor layer on a first surface and a second surface of a substrate, respectively, and a plurality of vias electrically connected between the plurality of connection pads and conductor layer.

12. The capacitive touchpad of claim 11, wherein the first insulator layer comprises a transparent insulator.

13. The capacitive touchpad of claim 11, wherein the first insulator layer comprises an opaque insulator.

14. The capacitive touchpad of claim 11, wherein the X and Y traces each comprises a conductive material of low resistance.

15. The capacitive touchpad of claim 14, wherein the conductive material of low resistance comprises a silver glue.

16. The capacitive touchpad of claim 11, wherein the second insulator layer comprises a dielectric constant of 2-4.

17. The capacitive touchpad of claim 11, wherein the second insulator layer comprises a transparent insulator.

18. The capacitive touchpad of claim 11, wherein the second insulator layer comprises a layer of ink.

19. The capacitive touchpad of claim 11, wherein the conductor layer comprises a copper film.

20. The capacitive touchpad of claim 11, wherein the substrate comprises a glass fiber-based plate.

21. A method for forming a capacitive touchpad, comprising the steps of:
producing a printed circuit board having a plurality of connection pads on a surface of the printed circuit board;
producing a membrane by printing a Y trace on a first insulator layer, forming a second insulator layer over the Y trace, printing an X trace on the second insulator layer, and forming a third insulator layer over the X trace; and
combining the printed circuit board with the membrane including having the plurality of connection pads electrically connected to the X and Y traces.

22. The method of claim 21, wherein the step of combining the printed circuit board with the membrane comprises the steps of:
coating a plurality of trace joints of the X and Y traces or the connection pads with a conductive glue; and
pressing the plurality of trace joints onto the connection pads for electrically connecting therebetween.

23. The method of claim 22, wherein the step of pressing the plurality of trace joints onto the connection pads comprises a thermal pressing under a high temperature.

24. A method for forming a capacitive touchpad, comprising the steps of:
printing an X trace on a printed circuit board;
forming a first insulator layer over the X trace;
printing a Y trace on the first insulator layer; and
attaching a second insulator layer onto the Y trace.
